(19) United States
(12) Patent Application Publication
(10) Pub. No.: US 2005/0263184 A1
(43) Pub. Date: Dec. 1, 2005

(54) System and method for supplying chemicals

(76) Inventors: Dae-Yong Choi, Gyeonggi-do (KR); Kyung-Soo Song, Gyeonggi-do (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/088,188

(22) Filed: Mar. 24, 2005

(30) Foreign Application Priority Data
May 28, 2004 (KR) 2004-38158

(51) Int. Cl. G05D 11/00

(52) U.S. Cl. 137/113

(57) ABSTRACT

A system and method of supplying continuous chemical to a processing area for use in manufacturing a semiconductor device are provided. First and second storage vessels store chemical. A sensor checks and senses whether conduits respectively connected with the first and second storage vessels are empty. A 3-way valve selectively connects the conduits respectively connected with the first and second storage vessels, with a conduit connected to the processing area, so that chemical of the first and second storage vessels can be selectively supplied to the process area. A controller controls the 3-way valve in response to outputs of the first and second sensors. A pump is installed on a conduit for connecting the 3-way valve to the processing area and provides a flow pressure to the chemical.

### BACKGROUND AND SUMMARY

1. Field of the Invention

The present invention generally relates to a system used in a semiconductor manufacturing process capable of continuously supplying chemicals to a processing area.

A claim of priority is made to Korean Patent Application 2004-38158, filed on May 28, 2004, the contents of which are hereby incorporated by reference in their entirety.

2. Description of the Related Arts

Recently there have been rapid improvements in the information media field such as computers. This rapid progress has also brought about rapid improvements in semiconductor devices such as a semiconductor memory device. Current semiconductor devices require high integration and quality with low manufacturing expense to guarantee competitiveness. High integration requires a scale-down in the size of electronic components, for example, lowering the thickness of a gate oxide and shortening a channel length for a transistor device. Semiconductor manufacturing process and manufacturing systems are under continuous developing stages.

In particular, manufactures of semiconductor devices require the use of high performing manufacturing systems, therefore, the use of manufacturing systems is rising in importance.

In general, a semiconductor device is fabricated through series of repetitive and selective processes such as photolithography, etching, diffusion, chemical vapor deposition, ion implantation, and metal deposition.

A semiconductor device manufacturing system requires a chemical supply system to supply various types of chemical to form circuit patterns on the semiconductor device. A conventional chemical supply system is constructed of various valves and chemical supply conduits. The supply of chemicals is limited by process conditions, such as supply volume, supply pressure, temperature, and chemical density.

To prevent a semiconductor substrate from being exposed to air or moisture during a manufacturing process, a layer of polymide is sometimes applied to the semiconductor substrate. For this process, a chemical supply system is used for the application of the polymide layer.

Pix is a polymide material, which has high viscosity over about 1000 cp. “cp” being a unit of viscosity. Chemical having a viscosity over 1000 cp is generally considered high viscosity chemical.

FIG. 1 illustrates a conventional chemical supply system.

Referring to FIG. 1, a conventional chemical supply system includes a storage vessel 10 to store high-viscosity chemical such as polymide, a gas supply source 50 to supply gas such as nitrogen N₂ into storage vessel 10, a transfer conduit 17 to supply chemical stored in storage vessel 10 to a processing area 40, a trap tank 12 to remove bubbles from the chemical, a drain source 30 to discharge the bubbles removed from the chemical, and a pump 18 to provide flow pressure to the chemical. Further, a sensor 14 is equipped to detect a level of the chemical and send an output signal INPUT A through a line 32 to a board 16. Board 16 is adapted to cut off the chemical in response to output signal INPUT A. Afterwards, storage vessel 10 is replenished with chemical.

Reference numbers 11 and 15 are valves installed on conduits 9 and 20, respectively.

The conventional chemical supply system continuously supplies nitrogen gas N₂ into storage vessel 10 from gas supply source 50. Also, under pressure, the chemical from storage vessel 10 is supplied to processing area 40 through transfer conduit 17.

The conventional chemical supply system is inefficient because of the numerous down time required to replenish chemical when storage vessel 10 is empty.

Accordingly, it is desirable to provide a system and method of continuously supplying chemicals.

### SUMMARY OF THE INVENTION

According to an exemplary embodiment of the present invention, a chemical supply system used in the manufacturing of semiconductor devices, the system containing at least two storage vessels to store chemical, at least two supply conduits respectively connecting the at least two storage vessels to a 3-way valve, a sensor in communication with and adapted to monitor the at least two storage vessels, a process conduit connecting the 3-way valve to a processing area, and supplying the chemical to the processing area, a controller connected to the sensor to receive a signal from the sensor, and adapted to control the 3-way valve in response to the signal, and a pump disposed between the 3-way valve and the processing area to pump the chemical from the at least two storage vessels to the processing area.

According to another exemplary embodiment of the present invention, a chemical supply system used in the manufacturing of semiconductor devices, the system containing first and second storage vessels to store chemical, first and second supply conduits respectively connecting the first and second storage vessels to a 3-way valve, first and second sensors respectively in communication with and adapted to monitor the first and second storage vessels, a process conduit connecting the 3-way valve to a processing area, and supplying the chemical to the processing area, a controller connected to the first and second sensors to receive a signal from either the first or second sensor, and adapted to control the 3-way valve in response to the signal, and a pump disposed between the 3-way valve and the processing area to pump the chemical from the first and second storage vessels to the processing area.

The present invention also discloses a method of supplying chemical to a processing area, the method comprising, supplying chemical from a first storage vessel to a processing area, detecting whether the first storage vessel is empty, switching a 3-way valve connection between the first storage vessel to the processing area and a connection between a second storage vessel and the processing area upon a determination by a controller that the first storage vessel is empty, thereafter, supplying chemical stored from the second storage vessel to the processing area, and replenishing the first storage vessel with chemical.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic view illustrating a conventional chemical supply system; and

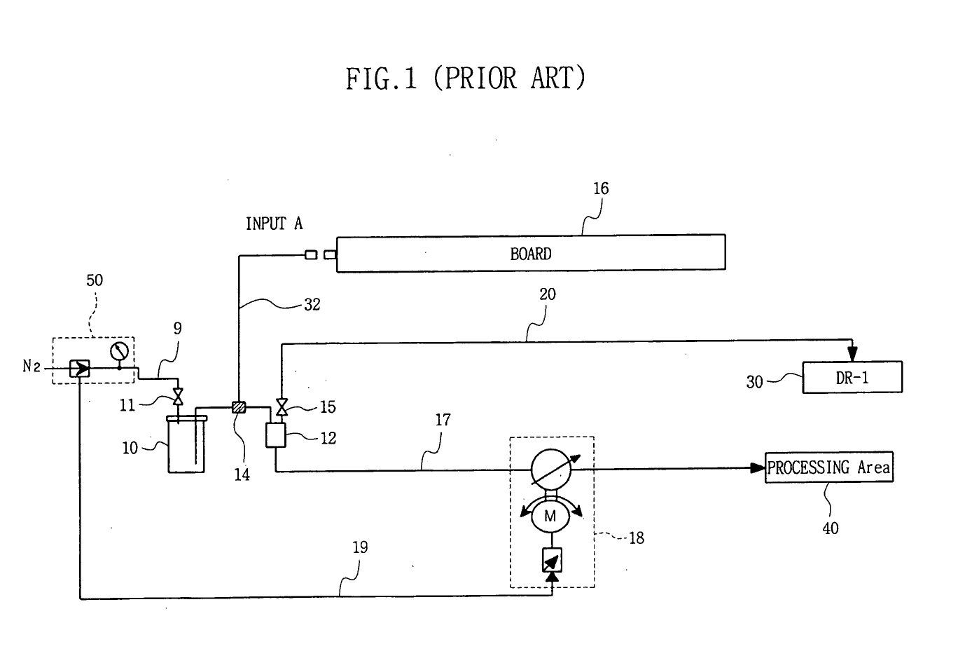

FIG. 2 is a schematic view illustrating a chemical supply system according to the present invention.

### DETAILED DESCRIPTION

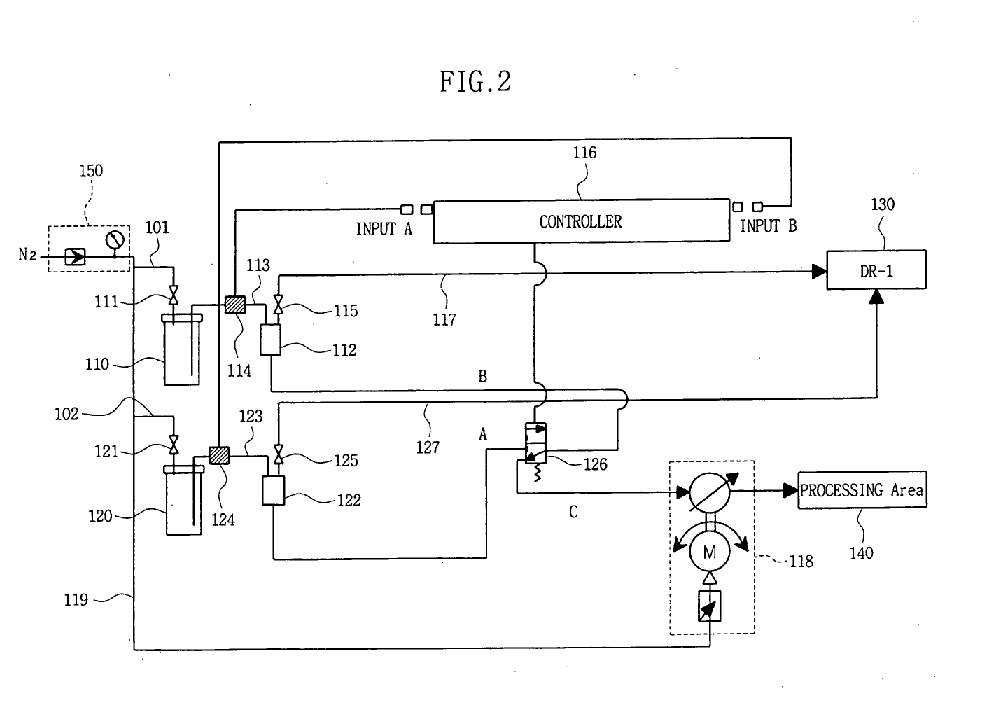

Hereinafter, exemplary embodiments of the present invention will be described in detail with reference to FIG. 2. It will be understood by those skilled in the art that the present invention can be embodied in numerous different types and is not limited to the following described embodiments. The following various embodiments are exemplary in nature.

Referring to FIG. 2, a chemical supply system includes a first storage vessel 110; a second storage vessel 120; a first sensor 114; a second sensor 124; a 3-way valve 126; a pump 118; and, a controller 116. The system further includes a first trap tank 112; a second trap tank 122; a gas supply source 150; a first gas conduit 101 disposed between gas supply source 150 and first storage vessel 110, a first supply conduit 113 disposed between first storage vessel 110 and first tap tank 112, a second gas conduit 119 disposed between gas supply source 150 and pump 118, a third gas conduit 102 disposed between gas supply source 150 and second storage vessel 120, a second supply conduit 123 disposed between second storage vessel 120 and second trap tank 122, a third supply conduit A disposed between second trap tank 122 and 3-way valve 126, a fourth supply conduit B disposed between first trap tank 112 and 3-way valve 126, a fifth conduit C disposed between 3-way valve 126 and pump 118, a first drain conduit 117 disposed between first trap tank 112 and a drain source 130, and a second drain conduit 127 disposed between second trap tank 122 and 3-way valve 126; and, valves 111, 121, 115 and 125 individually installed on conduits 101, 102, 117, and 127, respectively.

First storage vessel 110 and second storage vessel 120 each stores chemical. First storage vessel 110 and second storage vessel 120 are each connected to gas supply source 150 through first and second gas conduits 101 and 102, respectively. The chemical is preferably high-viscosity chemical, and the gas is preferably nitrogen gas.

First sensor 114 and second sensor 124 are preferably installed on first and second conduits 113 and 123, respectively, to individually measure the volume of chemical supplied through first and second supply conduits 113 and 123, sense when first storage vessel 110 or second storage vessel 120 is empty, and to output a signal to controller 116.

Controller 116 controls 3-way valve 126 and is adapted to receive an output signal INPUT A from first sensor 114 or an output signal INPUT B from second sensor 124. Controller 116 is preferably configured to control the operation of valves 111, 121, 115, and 125 and pump 118 to supply chemical. Controller 116 may be further provided with an alarm device (not shown) to respond to output signals INPUT A and INPUT B.

Chemical is supplied from first trap tank 112 or second trap tank 122 through first and second supply conduits 113 and 123, respectively, to 3-way valve 126. First trap tank 112 and second trap tank 122 are adapted to remove bubbles from the chemical, and also to temporarily store the chemical. Bubbles removed from the chemical are discharged to a drain source 130 through valves 115 and 125 and first and second drain conduits 117 and 127, respectively.

Three-way valve 126 is controlled by controller 116 and adapted to selectively connect third and fourth supply conduits A and B with fifth supply conduit C.

Pump 118 is installed on fifth supply conduit C and provides flow pressure to chemical. In other words, gas supplied by gas supply source 150 to pump 118 turns on or off a valve (not shown).

Gas supply source 150 supplies gas to first storage vessel 110, second storage vessel 120, and pump 118, to apply pressure to chemical, so as to easily supply the chemical to processing area 140.

Chemical supplied from storage vessels 110 and 120 to processing area 140 may be filtered by a filter (not shown).

Operations of the chemical supply system according to an exemplary embodiment of the present invention will now be described.

First, chemical stored in first storage vessel 110 is supplied through first supply conduit 113 under pressure of nitrogen gas supplied from gas supply source 150, and temporarily stored in first trap tank 112. First trap tank 112 removes bubbles from the chemical and discharges the bubbles to drain source 130 through first drain conduit 117.

Then the chemical passes through fourth supply conduit B, through 3-way valve 126 and fifth supply conduit C. The chemical is pumped by pump 118 and supplied to processing area 140. When first storage vessel 110 is near empty, first sensor 114 outputs an output signal INPUT A to controller 116.

Controller 116 sends a signal to 3-way valve 126 to release a connection between fourth supply conduit B with fifth supply conduit C, and to connect third supply conduit A with fifth supply conduit C.

At this time, first storage vessel 110 is replaced with a new storage vessel filled with chemical, or first vessel 110 is re-filled with chemical.

A chemical supply operation from second storage vessel 120 is similar to that of the chemical supply operation from first storage vessel 110. Therefore, continuous supply of chemical may be adapted without interruption, thereby to reduce lost time.

When second storage vessel 120 is empty, second sensor 124 outputs an output signal INPUT B to controller 115. Controller 116 sends a signal to 3-way valve 126 in response to the output signal INPUT B by reconnecting fourth supply conduit B with fifth supply conduit C.

By such continuous operation, chemical can be continuously supplied without interruption.

As described above, according to an exemplary embodiment of the present invention, a supply of chemical can be continuously performed without interruption, thereby reducing lost time caused by replenish the chemical storage vessel.

It will be apparent to those skilled in the art that modifications and variations can be made in the present invention without deviating from the scope of the present invention.

1. A chemical supply system used in the manufacturing of semiconductor devices, the system comprising:
at least two storage vessels to store chemical;
at least two supply conduits respectively connecting the at least two storage vessels to a 3-way valve;
a sensor in communication with and adapted to monitor the at least two storage vessels;
a process conduit connecting the 3-way valve to a processing area, and supplying the chemical to the processing area;
a controller connected to the sensor to receive a signal from the sensor, and adapted to control the 3-way valve in response to the signal; and
a pump disposed between the 3-way valve and the processing area to pump the chemical from the at least two storage vessels to the processing area.

2. The system of claim 1, further comprising at least two trap tanks respectively connected to the at least two storage vessels, and at least two sensors respectively disposed between the at least two storage vessels and the at least two trap tanks.

3. The system of claim 2, further comprising at least two drain conduits respectively connecting the at least two traps tanks to a drain source.

4. The system of claim 2, wherein a signal from one of the at least two sensors indicates to the controller that one of the at least two storage vessel is empty, and wherein the controller in response to the signal from one of the at least two sensors controls the 3-way valve to connect a supply conduit not connected to the empty storage vessel with the processing area.

5. The system of claim 1, further comprising a gas supply source to apply gas pressure to the first and second storage vessels and the pump.

6. The system of claim 4, further comprising an alarm device response to the signal from one of the at least two sensors.

7. The system of claim 1, further comprising a filter to filter the chemical prior to the chemical reaching the processing area.

8. A chemical supply system used in the manufacturing of semiconductor devices, the system comprising:
first and second storage vessels to store chemical;
first and second supply conduits respectively connecting the first and second storage vessels to a 3-way valve;
first and second sensors respectively in communication with and adapted to monitor the first and second storage vessels;
a process conduit connecting the 3-way valve to a processing area, and supplying the chemical to the processing area;
a controller connected to the first and second sensors to receive a signal from either the first or second sensor, and adapted to control the 3-way valve in response to the signal; and
a pump disposed between the 3-way valve and the processing area to pump the chemical from the first and second storage vessels to the processing area.

9. The system of claim 8, further comprising first and second trap tanks respectively connected to the first and second storage vessels.

10. The system of claim 9, further comprising first and second drain conduits respectively connecting the first and second traps tanks to a drain source.

11. The system of claim 9, wherein the signal from the first or second sensor indicates to the controller that the first or second storage vessel is empty, and wherein the controller in response to the signal controls the 3-way valve to connect the first or second supply conduit not connected to the empty storage vessel with the processing area.

12. The system of claim 9, further comprising a gas supply source to apply gas pressure to the first and second storage vessels and the pump.

13. The system of claim 11, further comprising an alarm device responsive to the signal by one of the first and second sensors.

14. The system of claim 9, further comprising a filter to filter the chemical prior to the chemical reaching the processing area.

15. A method of supplying chemical to a processing area, the method comprising:
supplying chemical from a first storage vessel to a processing area;
detecting whether the first storage vessel is empty;
switching a 3-way valve connection between the first storage vessel to the processing area and a connection between a second storage vessel and the processing area upon a determination by a controller that the first storage vessel is empty;
thereafter, supplying chemical stored from the second storage vessel to the processing area; and
replenishing the first storage vessel with chemical.

16. The method of claim 15, further comprising removing bubbles from the chemical prior to supplying the chemical to the processing area.

17. The method of claim 15, further comprising filtering the chemical prior to the chemical reaching the processing area.

18. The method of claim 15, wherein gas supplied from a gas supply source pressurizes the first and second storage vessels to move chemical to first and second trap tanks, respectively.

19. The method of claim 18, wherein the gas supplied from the gas supply source also controls a pump to pump the chemical from the first and second trap tanks to the processing area.
